(19) United States
(12) Patent Application Publication
(10) Pub. No.: US 2026/0163859 A1
(43) Pub. Date: Jun. 11, 2026

(54) Method and system for managing communications

(71) Applicant: PrivacyLinks B.V., 3015 GM Rotterdam (NL)

(72) Inventor: Tijn Martinus Maria KOOIJMANS, Rotterdam (NL)

(21) Appl. No.: 19/129,195

(22) PCT Filed: Nov. 7, 2023
(86) PCT No.: PCT/EP2023/081071

§ 371 Date: May 12, 2025

(30) Foreign Application Priority Data
Nov. 11, 2022 (NL) 1044464

(51) Int. Cl. H04L 51/56; G06F 16/955; H04L 67/02

(52) U.S. Cl. CPC H04L 51/56; G06F 16/955; H04L 67/02

(57) ABSTRACT

Method for managing communication between a first user and a second user, wherein a specific URL (uniform resource locator) is generated for the first user, which URL is made available to at least the second user, wherein the second user is enabled to establish a communication channel with the first user by using said URL, wherein the URL refers the second user to a web page of a web based computer system, wherein at said web page a choice is provided for a communication mode from a series of communication modes, including at least one and preferably at least two of VOIP, text messaging, video communication, voice messaging and emailing.

The invention relates to a method and system for managing communication between a first user and a second user. The invention relates to a method and system for communication between a first and second user of a communication system in which privacy of the first user can be preserved.

When ordering products or services on-line, for example food such as ready meals, electronics, books, groceries or any other product or service a user has to provide credentials on-line, including personal information such as a telephone number. Also, when for example ordering a product or service in a shop or the like, or when purchasing products through the Internet, or requesting service for a product or surface service previously purchased a user has to provide a telephone number or email address to the other party. This telephone number or email address will be stored by the other party for later use. Such storage of telephone numbers or email addresses is however vulnerable to misuse. For example, the telephone number or email address can be used unauthorized by the other person or by a third person having access to a database in which said telephone numbers and/or email addresses are stored. For example, by hacking into said data base. Another problem of providing the telephone number and/or email address to the second user can be that the telephone number and/or email address can be sold on by the second user. This will all mean that the telephone numbers and/or email addresses will be compromised and the first user will lose all control over his or her telephone number and/or email address.

In order to prevent or at least partly overcome this problem with email addresses it is known for Internet providers or service companies to provide customers with multiple email addresses or allow their customers to construct such email addresses. It is furthermore known for telephone companies to enable clients to purchase multiple telephone numbers to be used with their mobile phone. If one of these email addresses or phone numbers is compromised, the user can then discard said telephone number or email address. Especially for telephone numbers this is very costly, since only a very limited telephone numbers will be available for a network.

An aim of the present disclosure is to provide for an alternative method for managing communication between a first user and a second user. An aim is to provide for a method for managing communication in which compromising of a means of communication leads to less problems for at least one of the users. An aim is to provide for a method of management of communication between a first and second user allowing for providing more freedom in communication between the said first and second user.

In an aspect a method according to the disclosure for managing communication between a first user and a second user comprises the steps of generating a specific URL (uniform resource locator) for the first user, which URL is made available to at least the second user. The second user establishes a communication channel with the first user by using said URL, wherein the URL refers the second user to a web page of a web-based computer system. At said web page a choice is provided to the second user for a communication mode from a series of communication modes, including at least one and preferably at least two of VOIP, text messaging, video communication, voice messaging and emailing.

In such method the second user can for example be offered a choice of only one mode of communication, for example VOIP or chat, or can be offered a choice between two or more modes of communication. The first user does not have to provide his or her regular telephone number or email address otherwise used to the second user since the specific URL will provide for or at least allow for the said communication.

Preferably in a method according to the disclosure at least one of the first user and second user registers in the said computer system for the URL which communication modes are to be made available to the other of the first user and the second user when using the URL.

In such method for example the first user can for example chose to provide the second user with a list of two or three or more such modes to choose from, or prescribe just one such mode of communication, for example only VOIP.

In embodiments of a method according to the disclosure a series of different URL's is or at least can be generated for the first user or to the second user, wherein the relevant user is enabled to register for each URL which of the communication modes are to be made available to the other user when using the URL.

In such method for example the first user can provide different second user with different URL's, which will allow the different second users to use different modes of communication. Additionally or alternatively, the first user can make available different URL's to the same second user, allowing for different modes of communication, for example for the second user to use for different actions. For example, with regards to different products or services provided to or requested by the first user. Preferably the first user can use the same URL cq communication mode with respect to the second user too.

In embodiments of a method according to the disclosure the first user or second user sets for at least one communication mode whether said communication mode allows for the possibility of one way communication or two way communication between the first user and the second user during at least part of the time the URL is available to the first and/or second user.

As will be discussed in embodiments of a method according to the disclosure the first user can register for the one or multiple URL's for example different possible choices for different modes of communication for different time slots. For example but not limited to the first user could make available VOIP as a choice for a mode of communication during working hours, but not for non-working hours, or the other way round. For example, it would be beneficial to the first user to make available VOIP as a choice of communication to the second user, possibly the only choice, during a specific time slot during which the first user would prefer to be contacted by the second user directly during said time slot, for example, but not limited to, when the second user is a delivery person delivering goods to the first user. The first user can then make available to the second user another mode of communication, for example chat or email, or no means for communication for other time slots during which the first user wishes not to communicate with or receive communication from the second user, or assign a different first user to said URL for such time slot.

In such embodiments of a method according to the disclosure the first or second user can register for the or each URL at least:
one time slot during which said URL can be used and/or when one or more of the communication modes registered for said URL can be used; and/or
one time slot during which said URL cannot be used and/or when one or more of the communication modes registered for said URL cannot be used.

In embodiments of a method according to the disclosure the first user or second user is enabled to allocate said at least one URL to a specified second user or first user and/or to a product and/or service provided by or for said user.

The at least one URL used in a method according to the disclosure is preferably a unique URL, preferably a URL generated by said computer system.

In embodiments of a method according to the disclosure the first user or second user can assign an alias to the or each URL, wherein said alias is preferably stored by the first user and/or second user for later use and/or is used for making the URL available to the other of the first and second user.

Assigning an alias to a URL can be useful to the first and/or second user, for example in retrieving the URL again, and in assigning the URL for example to a specific first or second user, to a product or to a service. For example, but not limited to, a first user can assign an alias to a URL made available to a second user, for example by at least said alias, which alias can for example be related to the second user and/or a product or service of said second user. Preferably in a method according to the disclosure then the said alias is shown to the first user when the second user is trying to set up a mode of communication with the first user or vice versa. Thus it will be directly apparent to the first user which second user is trying to reach him or her and/or on what topic the second user tries to reach her or him or vice versa.

In embodiments of a method according to the disclosure the URL is made available through a code, especially a QR code. The code can also be an alias. Such QR code can then be made available to the other of the first and second user, for example electronically and/or in hardware form, such as for example but not limited to in printed form, which can form a physical or visual representation. The code can additionally or alternatively be provided through an electronical system, such as for example but not limited to an NFC tag, BleuTooth, WiFi or the like.

In embodiments of a method according to the disclosure the URL is made available to the first and/or second user electronically, preferably through an electronic form. In such method the URL can be made available via any suitable electronic medium, such as but not limited to via email, app, chat, website, electronic form or the like.

In embodiments of a method according to the disclosure the relevant user can register in the computer system an expiry date for the URL.

Such method allows the user to make available the URL to the other of the first and second user for a predetermined period only, or until for example a specific event happens, such as for example delivery of a product, performance or a service or occurrence of a predefined event.

In embodiments of methods according to the disclosure in the computer system the first user can assign at least one further contact who can be contacted by the second user through the URL, or vice versa.

In such embodiments for example the first user can define in the computer system whether a second or further contact can be contacted through the URL too, for example in order to avoid that no contact can be achieved when the first user is not available. The first user can for example define an order in the contacts, such that if the first user cannot be contacted within a defined period of time, a second contact can be contacted by the second user, whereas if the second contact cannot be reached, a still further contact may be contacted.

In embodiments of methods according to the disclosure the first or second user opens a web page or web form through the Internet, wherein:
the first user enters said URL on said web page or web form; or
said URL is generated for the first user through the said web page and made available to the second user and to the first user through said web page or web form; or
said URL is generated for the first user by a separate web page and made available to the second user, preferably directly by said separate web page.

In such embodiments the URL is used in or for a web form or web page where the first user is requested to provide contact information. By making the URL available the first user can provide such contact information without having to enter a telephone number or email address as such.

The disclosure is further directed to a system for enabling communication between a first user and a second user, wherein the system further comprises a first communication device for the first user and a second communication device for the second user, said system further comprising a web-based computer system comprising at least a generator for generating unique URL's, wherein the computer system is programmed to:
upon request from the first user generating a unique URL and transmitting said URL to the first user for making the URL available to the second user; and/or
upon request from the first user generating a unique URL and transmitting said URL to the second user; and/or
upon request from the second user generating a unique URL and making the URL available to the first user.

With a system according to the disclosure communication between a first user and a second user can be enabled without the first user having to provide directly for example a telephone number or email address, or vice versa, thus limiting the risk that such telephone number or email address may become compromised.

In embodiments of a system according to the disclosure the first communication device can be or can comprise at least one of a mobile phone or tablet and/or a computer, connected to or connectable to the computer system, wherein the second communication device can be or can comprise at least a mobile phone or tablet and/or a computer, connected to or connectable to the computer system, wherein in such embodiments through the second communication device a website is made available to the first user on the first communication device, and wherein the URL is made available to the second user on said web site. A System or method according to the disclosure can entirely or in part be app based.

In embodiments of a system according to the disclosure the computer system comprises at least said generator and said computer system comprises at least a computer program enabling a user to:
assign to said URL at least one communication mode, wherein said at least one communication mode is preferably chosen including at least one and preferably at least two of VOIP, text messaging, video communication, voice messaging and emailing; and/or
assign to said URL at least one time slot during which said at least one communication mode is to be made available; and/or
assign to said URL at least one time slot during which said at least one communication mode is not to be made available; and/or
assign an alias to said URL; and/or
allocate said at least one URL to a specified first and/or second user and/or to a product and/or service provided by or for said second user; and/or
assign an expiry date for the URL.

With such embodiments of a system according to the disclosure the relevant user can control for example communication modes, time slots, information enclosed in said URL and/or aliases assigned to such URL's and the like, providing improved control of such communications.

For example, but not limited to, the first user can assign a specific URL to a specific product obtained or to be obtained from a specific second user, such that if the second user wants to communicate with the first user about said product the second user can use said URL, informing the first user that the communication will be about said product, thus allowing the first user to decide whether he or she wishes to communicate at that moment with the second user about said product. Whereas the first user can also define when the second user can (or cannot) use said URL to try and communicate with the first user, for example only during working hours or only in the evening or during the weekend or any such time slot or multiple time slots. The first user can preferably also delete the URL or set an end date at which the URL will expire, such that it can no longer be used. For example, but not limited to, the first user can make the URL only available during a specific day, week or month or other period, during a holiday or a specific event, such as a festival, conference or the like.

Preferably the first user and/or the second user can combine different settings as discussed here above, such as for example, but not limited to, making different sets of communication modes available to choose from for the same URL during different time slots, such as different modes including VOIP during working hours but communication modes without VOIP outside working hours, or vice versa.

In a system or method according to the disclosure the same URL can be made available to a series of second users or the same URL can be made available by a second user to a series of first users, for example such that a first user can communicate with a group of second user though the same URL and/or vice versa.

The disclosure is further directed to a computer readable computer product comprising computer readable instructions for performing a method according to the present disclosure, and to a computer system, comprising at least a computer program designed for performing a method according to the disclosure.

In this disclosure when referring to an embodiment or embodiments according to the disclosure having specific features should be understood at least as also meaning that such embodiments could also have some or all of the features of other embodiments described or otherwise disclosed in this disclosure.

The invention will be further elucidated on the basis of the exemplary embodiments that are represented in the drawing. In the drawing shows:

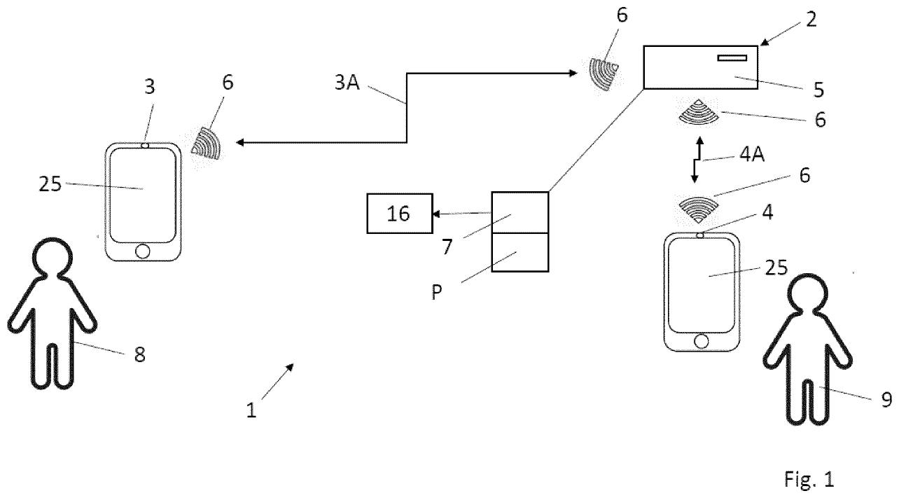

FIG. 1 a schematic view of a system according to the disclosure, for performing a method according to the disclosure;

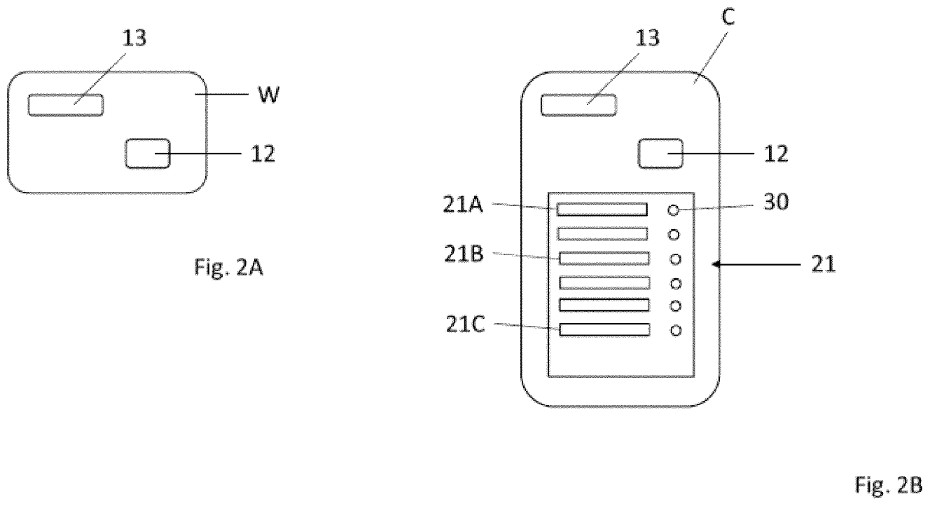

FIG. 2A schematically a representation of a basic website for requesting a URL;

FIG. 2B schematically a representation of a website for ordering for example a product or service or for sharing information, with a button for requesting a URL;

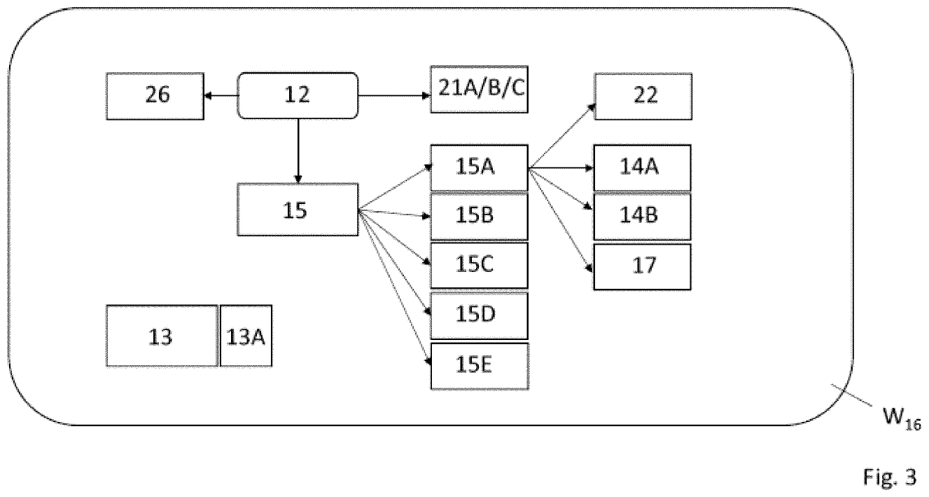

FIG. 3 schematically a representation of an access page for configuring functionalities and assets of a URL;

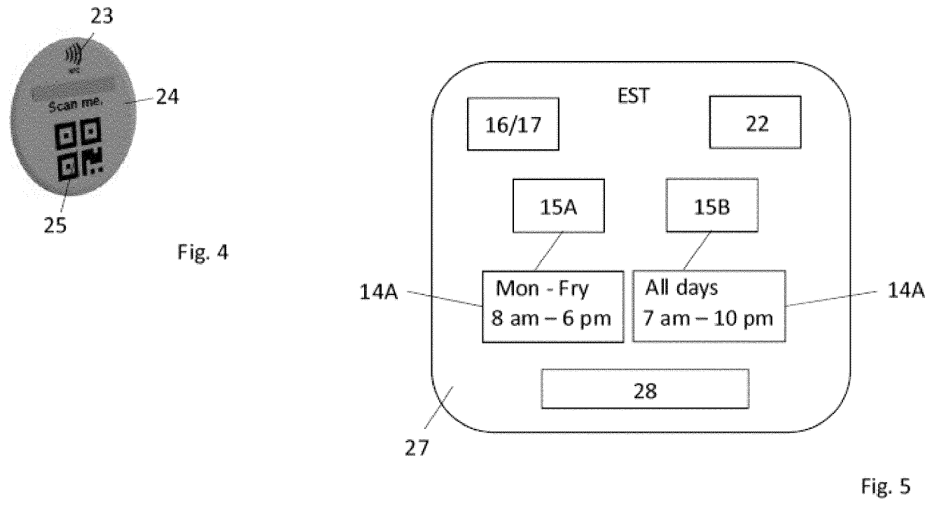

FIG. 4 schematically a carrier with representations of a code associated with a URL, said code being readable electronically and/or visually;

FIG. 5 schematically a representation of an access page or landing page associated with a URL, showing for example availability of one or more communication modes, time slots, alias and an information field;

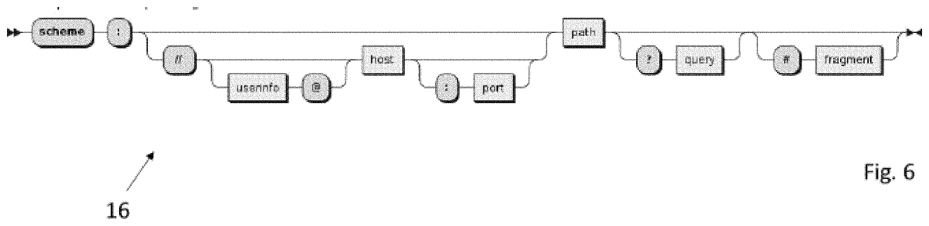

FIG. 6 schematically a general configuration of a URL (source Wikipedia.com);

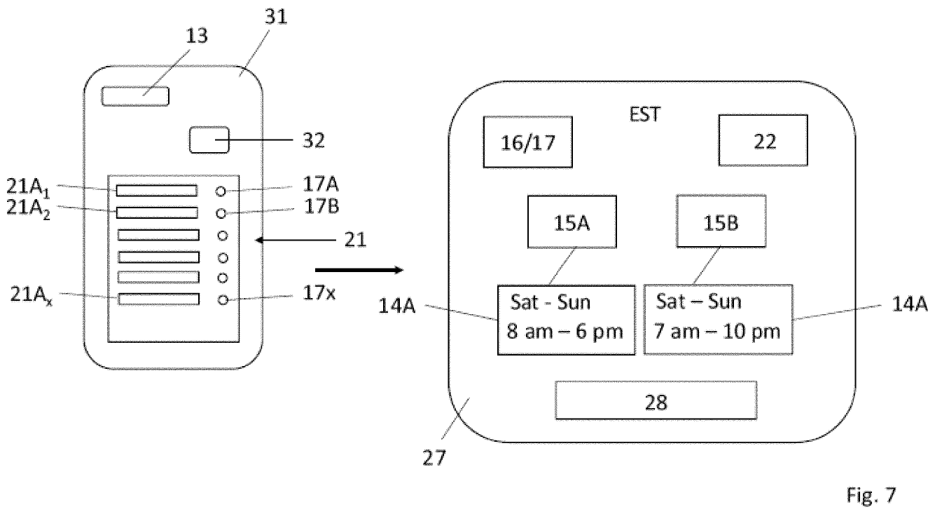

FIG. 7 schematically a representation of a website with a variety of products, services and/or information available, with representations of aliases of unique URL's associated therewith, and of an access page or landing page to which such alias cq URL refers;

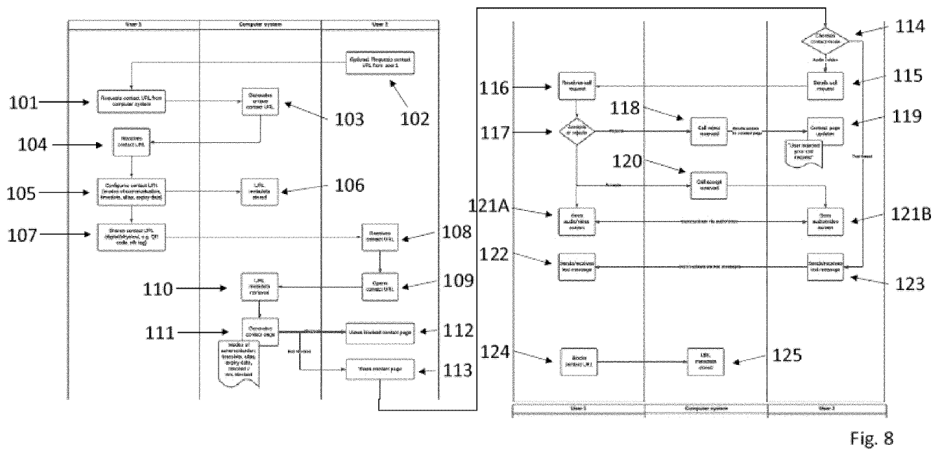

FIG. 8 schematically a flow diagram of a method according to the disclosure; and

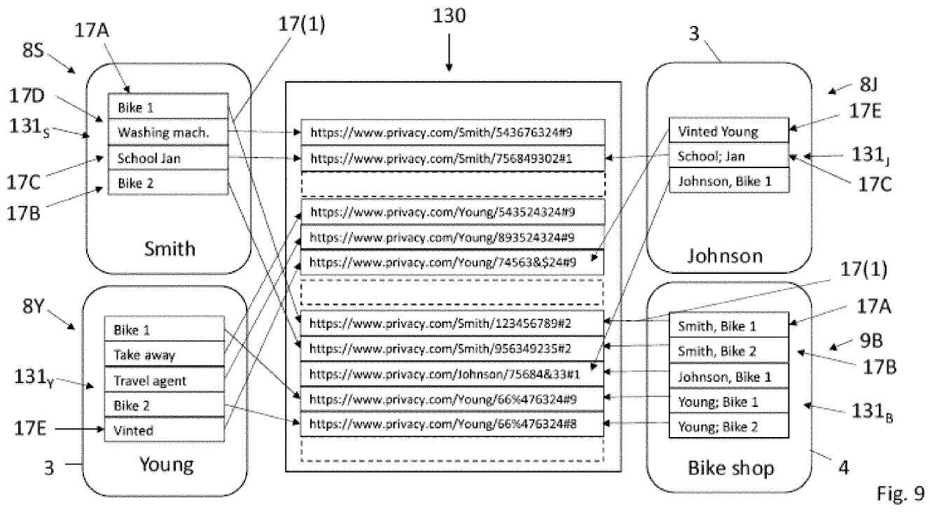

FIG. 9 schematically a series of electronic address books of users and URL's associated therewith.

The figures are only schematic representations of preferred embodiments of the invention. These embodiments are only shown as example for a better understanding of the claimed invention and should not be considered as limiting the disclosure to these embodiments. In the figures, like or corresponding parts are indicated with the same reference numerals.

In this disclosure by way of example embodiments of systems and methods will be described with which users of the system or method can protect their privacy and nevertheless can establish contact with each other using electronic communication devices. These embodiments are disclosed by way of examples and should not be considered limiting the scope of the disclosure to such specifically disclosed embodiments.

In a method according to the disclosure a specific URL (uniform resource locator) is generated for the first user, which URL is made available to at least the second user. The second user can then establish a communication channel with the first user by using said URL. The URL refers the second user to a web page of a web based computer system, wherein at said web page a choice is provided for a communication mode from a series of communication modes. These communication modes include at least one and preferably at least two of VOIP, text messaging, video communication, voice messaging and emailing.

A uniform resource locator (URL) should at least be understood as a reference to a web resource that specifies its location on a computer network and a mechanism for retrieving it. A URL can also be understood as a handle or a web address. A URL can for example be but is not limited to a web page (http), a file transfer (ftp), email (mailto), database access (JDBC) or the like. In the present disclosure a URL is preferably a web address or a reference or locator to a web page. Web should in this disclosure be understood as at least meaning the Internet, in the broadest sense, but may also be a different computer network to which users communication devices can be coupled. A typical URL for use in a method or system according to the disclosure can for example comprise a protocol definition, such as “http:” or “https:”, a hostname, like “www.example.com”, and a file index, like “index.html”. Such URL can then for example read http://www.example.com/index.html. Obviously other such URL structures can be used, as is known in the art, including but not limited to URL's with more complex file indexes, such as indexes including sub-indexes.

URL's used in a method or system according to the disclosure preferably comply with the syntax diagram of a generic URI (Uniform Resource Identifier), as for example shown schematically in FIG. 6, as is known in the art.

In the present disclosure a URL can for example have a configuration in which user information refers to a website, such as for example “www.privacy.com”, and wherein a first part of the path can refer to a specific user, for example “Smith”, and a second part of the path can comprise for example an alpha numeric string of characters referring to a specific web page. A unique URL generated by the computer system can thus for example have a configuration like https://www.privacy.com/Smith/123456789#2, wherein when the same user requires a new unique URL in such new URL for example the second part of the path may change, whereas the first part may be the same. Obviously many different general configurations of URL's generated may be used in a system or method according to the disclosure.

A system according to the disclosure, for enabling communication between a first user and a second user, comprises a first communication device for the first user and a second communication device for the second user. Said system further comprises a web based computer system comprising at least a generator for generating unique URL's. The computer system can be programmed to perform at least one or more of the following:
upon request from the first user generating a unique URL and transmitting said URL to the first user for making the URL available to the second user;
upon request from the first user generating a unique URL and transmitting said URL to the second user;
upon request from the second user generating a unique URL and making the URL available to the first user.

In a method and system according to the disclosure obviously a person or corporate entity can perform the function of a first user or a second user, or can sometimes perform the role of a first user and sometimes the role of a second user.

In the present disclosure making available a URL should be understood as at least meaning that a URL, generated by the system, is made available by or on behalf of a user to at least one other user directly or indirectly, for example through an alias or a code, such as for example but not limited to a hyperlink, which the other user or users can use in order to establish communication with the user by or on behalf of whom the URL is made available. The URL can for example make accessible to the other user or users a web page associated with the URL, for choosing a mode of communication available for such communication, and/or for posting a message for the said user and/or retrieving a message by said user posted on said web page.

With a method or system according to the disclosure communication is made possible between a first user and a second user, without the first and/or second user having to disclose to the other of the first and second user his or her actual telephone number or email address or for example a personal website, or for example a name or address, if said user does not want to reveal such information.

FIG. 1 shows schematically a system 1 according to the disclosure, comprising a computer system 2, a first communication device 3 and a second communication device 4. In the embodiment shown the computer system 2 comprises a computer 5, here shown as a single computer 5, but it will be directly clear to the skilled person that this can also comprise multiple coupled computers 5 or stand-alone computers, a cloud-based computer system, servers and the like. The first communication device 3 and the second communication device 4 are here shown, by way of example only, as mobile phones. Either one or both of these communication devices 3, 4 can however also be of a different type, such as but not limited to a tablet, laptop computer, desktop computer or the like, which can communicate through or via a computer network and/or a digital communication network such as a telephone network and/or Internet. The first communication device 3 is assigned to a first user 8, the second communication device 4 to a second user 9.

Although in the examples shown in the drawings only a single first communication device 3 and a single second communication device 4 are shown, it will be clear that multiple first communication devices 3 and multiple second communication devices 4 can be, and generally will be part of the system 1. It will also be clear that all communication devices 3, 4 can sometimes perform functions in the system 1 as a first communication device 3 and sometimes as a second communication device 4. Hence also first users 8 can sometimes play the role of second users 9 and vice versa. As will be discussed the first communication device 3 and second communication device 4 can communicate with each other and other communication devices of the system through at least the computer system 2. In FIG. 1 this is schematically indicated by two-headed arrows 3A and 4A and communication symbols 6.

The computer system 2 is preferably a web-based computer system 2, which should be understood as meaning that the computer system is part of or connected to the Internet, such that communication between the communication devices 3, 4 can at least in part be established through the Internet. A computer system for use in the present disclosure can be app based or can comprise at least one or more associated apps for performing aspects of the claimed methods.

The computer system 2 comprises at least a generator 7 for generating unique URL's 16. The generator 7 is or comprises preferably a computer program, programmed to generate URL's 16 which are as discussed here before, to be used in the computer system 2 as hyperlinks which will direct a user of said URL 16 to a specific web page, preferably a web page uniquely coupled to said unique URL 16. The computer system 2 is programmed to perform at least one of the following tasks:
upon request from the first user 8 generating a unique URL 16 and transmitting said URL 16 to the first user 8 for making the URL 16 available to the second user 9; and/or
upon request from the first user 8 generating a unique URL 16 and transmitting said URL 16 to the second user 9; and/or
upon request from the second user 9 generating a unique URL 16 and making the URL 16 available to the first user 8.

In embodiments the first user 8 or the second user 9 can select one of these options to be used by the computer system 2.

In embodiments a website or web page W can be made available to a user 8, 9, as shown schematically on FIG. 2A, for example on a screen 10, 11 of the relevant first or second communication device 3, 4. On such website or web page W, which can also be referred to as access page W, which access page can be dedicated to the specific user 8, 9, or can be a generic access page W, the relevant first user or second user 8, 9 can request a URL 16 to be generated, for example by virtually pushing a button 12 presented on the access page W. The computer system 2 then generates a unique URL 16 for the relevant user 8, 9, who can then make said URL 16 available to one or more other users 8, 9 of the system, as will be discussed further.

On the access page W further fields 13 can be presented to the relevant user 8, 9, for providing additional information. For example, such information can comprise but need not be or be limited to personal information of the user, for example the first user 8, requesting the URL 16 and/or information of the further user or users, for example the second user 9, to whom the URL 16 is to be made available. As will be discussed, the computer system 2 will also provide at least one of the users 8, 9 involved with an opportunity to set different features for the URL 16, such as but not necessarily limited to availability of one or more different communication modes 15, time slots 14 during which the URL 16 and/or said different communication modes 15 will and/or will not be available for use, a period 14A during which or until which the relevant URL 16 will be available to the defined other user or users 9, 8, an alias 17 for the URL 16 and such features.

In embodiments of the system 1 through for example the second communication device 4 a website C, such as a company or personal website C, as for example schematically shown in FIG. 2B, is made available by the second user 9 to the first user 8 on the first communication device 3, and wherein the URL 16 is made available to the second user 9 on said web site C. In such embodiments for example on the company or personal website C a second user offers a variety 21 of products 21A and/or services 21B and/or information 21C or the like for the first user 8 to choose from, and/or options to for example request information, request contact or the like. On the same website C the button 12 is provided as discussed with reference to FIG. 2A, as well as the field or fields 13 for providing further relevant information. When making a choice from the variety 21 the first user 8 can fill in information on the field(s) 13 and “push” the button 12 to request a unique URL 16, as discussed, which will then be made available to the second user 9 for future use. In this embodiment for example the web site C triggers the generator 7 to generate the URL 16. The URL 16 can then also or alternatively be made available to the first user, for example to allow the first user 8 to add an alias to said URL, which can then be made available to the second user 9 for future use by the first user 8 and second user 9 for communication. Preferably the first user 8 and/or the second user 9 can select one of these options, whether the URL 16 is sent to the second user 9 or to the first user 8 or to both, to be used by the system 1.

In a system 1 according to the disclosure preferably the computer system 2 comprises at least said generator 7 and said computer system 2 preferably furthermore comprises at least a computer program P enabling a first user 8 and/or the second user 9 to perform one or more of the following tasks, as schematically shown in FIG. 3:
assign to said URL 16 at least one communication mode 15, wherein said at least one communication mode 15 is preferably chosen including at least one and preferably at least two of Voice over IP (VOIP) 15A, text messaging 15B, video communication 15C, voice messaging 15D and emailing 15E;
assign to said URL 16 at least one time slot 14A during which said at least one communication mode is to be made available to the second user 9 and/or to the first user 8;
assign to said URL 16 at least one time slot 14B during which said at least one communication mode 15 is not to be made available to the second user 9 and/or first user 8;
assign an alias 17 to said URL 16;
allocate said at least one URL 16 to a specified second user 9 and/or to a product 21A and/or service 21B and/or information 21C chosen or available from the variety 21 provided by or for said second user 9;
assign an expiry date 22 for the URL 16.

The relevant user 8, 9 can for example be referred to a web page W 16 dedicated to a specific, unique URL 16 or to the relevant user 8, 9 when a unique URL 16 is generated or later, on which web page W 16 the relevant user 8, 9 can make the choices from the possible modes, tasks and assignments 15-21 such as for example discussed here above with reference to FIGS. 2 and 3. Also a filed 13 can be provided for entering relevant personal information, if desired.

The relevant user 8, 9 can also be provided with a choice to assign or especially have assigned by the computer system 2 a code 22, especially an optically and/or electronically readable code 26, such as for example a QR code 25 or a code transmitted by an NFC chip 23 or the like electronic emitter. In embodiments the user 8, 9 can then make the code 22 available to another user, for example printed on a carrier 24, as schematically shown in FIG. 4, or on a screen 25, for example of a communication device 3, 4 as shown in FIG. 1, such that the other user can use the code 26 to use the URL 16 for communication with the relevant user designated to said URL 16.

In a system and method according to the disclosure preferably any URL 16 assigned to a first user 8 can be fully controlled by said first user 8, including the ability for the first user to disable the URL 16 for a specific second user 9 or even in its entirety.

A system 1 according to the disclosure can for example, but not limited to, be used with a method in which for managing communication between a first user 8 and a second user 9, wherein a specific URL (uniform resource locator) 16 is generated for the first user 8, which URL 16 is made available to at least the second user 9, wherein the second user 9 is enabled to establish a communication channel with the first user 8 by using said URL 16. The URL refers the second user 9 to a web page of a web-based computer system 2. At said web page W a choice is provided for a communication mode 15 from a series of communication modes 15A-E, including at least one and preferably at least two of VOIP, text messaging, video communication, voice messaging and emailing.

A number of examples of a method according to the disclosure will be discussed hereafter, by way of example only, not limiting the disclosure.

In an example a first user 8 accesses an access page W, C through his or her communication device 3 and presses the button 12 for generating a unique URL 16. Pressing a button should in this disclosure be understood as at least including touching a representation of a button on a screen 25, as known in the art. The URL is then made available to the relevant user 8, generated by the generator 7. The URL 16 can for example be made available on a related access site W₁₆ as for example shown in FIG. 3, on which page W₁₆ the first user 8 enters relevant information into the field 13, such as for example but not limited to personal information. Preferably the first user 8 can indicate whether such information entered can be available to the or each second user 9, either partly or in its entirety, for example by ticking an appropriate box 13A on said access site W. The first user 8 enters an alias 17 for the URL 16, and assigns one or more, preferably two or more communication modes 15 to the URL 16, for example VOIP 15A and text messaging 15B. The first user 8 further assigns a time slot 14 to the relevant communication modes 15. In this example the first user 8 assigns a time slot 14A during which VOIP 15A can be chosen to be used for communication between the first and second user 8, 9, for example during working days, Monday to Friday, between 8 am and 6 pm, EST. For the text messaging 15B in this example a time slot is entered for each day between 7 am and 10 pm, EST. Moreover, in the first user 8 enters an end time or expiry date 22 for the URL 16, in this example indicated as “end date”. The first user can for example make the URL available for several hours, several days, weeks or months, or any other period of time, including indefinitely. It shall be clear that also a computer program, such as e.g. an app, can be provided on a user's communication device for generating the or each or at least an URL as discussed. An app should be understood in at least its ordinary meaning. An app should at least be understood as an application designed for use on a mobile device such as a smartphone or tablet.

The first user 8 in this example also assigns at least one second user 9 to the URL 16, for example by entering said second user or users identity in the field 13. Then the first user 8 communicates the URL 16 to the relevant second user or second users 9, for example by transmitting the alias 17 and/or code 26 to the second user(s) 9. Alternatively, the URL 16 and/or the alias 17 and/or the code 26, such as QR code 25 is communicated directly to the second user from the web page W₁₆.

If the second user 9 thereafter wishes to communicate with the first user 8, the second user can enter the URL 16 on the Internet, which redirects the second user 9 to a communication page 27, for example a communication page 27 specifically dedicated to the unique URL 16. On said communication page 27 the available communication modes 15 are shown, with the relevant time slots 14A during which they can be used. Alternatively, only the communication mode(s) available at the time of entering said page 27 are shown to the second user 9. The second user 9 can chose one of the available communication modes 15 by pressing the relevant button 15A, B, 15ₙ after which a communication can be established between the second user 9 and the first user 8.

Preferably after choosing a communication mode 15 by the second user 9 a message is sent to the first user 8, indicating that the second user requests contact cq communication with the first user 9. Since the URL has been specifically designated to a second user or a group of second users 9, the first user 8 will be able to see who is requesting said contact, and can either accept or deny said request. The identity of the second user can for example be presented to the first user by the alias 17 assigned to the URL 16. Hence a communication channel can be established between the first and second user 8, 9, without the first user having to provide for example a telephone number or email address previously.

If the first user receives said message, he or she can deny the request, for example by ignoring it or by responding be a denying signal, for example by pushing a “deny” button on his communication device 3, as known in the art, for example from Whatsapp ®. Alternatively, the first user can enter a communication message 28 to the second user on the communication page 27, either prior to receiving said message or after receiving said message. For example, but not limited to, indicating when communication would be more convenient, or responding to a question from the second user 9.

For either one or both of the first and second user or users 8, 9 in all embodiments the relevant parts of the system can be made available by an apps installed on their communication devices.

In a second example a second user 9 requests a URL 16 to be generated by the generator 7, for example through ha website W as shown in FIG. 2A. The second user 9 can for example be a supplier of products 21A or services 21B. In such example the second user 9 can for example assign to the URL an alias 17, such as for example a product name or service name of a product 21A or service 21B provided to and/or to be delivered to a first user 8. The URL 16 or at least the alias 17 and/or the code 26 is then made available to a first user 8. The first user 8 then uses the URL 16 or the alias 17 or code 26 to access an access page W 16 as for example shown in FIG. 3, allowing the first user 9 to assign to said URL 16 for example communication modes 15, time slots 14, an expiry date 22 and/or a code 26 as discussed here before, e.g. with reference to the first example. Then whenever one of the first user 8 and the second user 9 intends to communicate to the other of the first user 8 and second user 9 about said product 21A or service 21B such user 8, 9 can use the URL 16, or at least the alias 17 or code 26 in order to establish communication with the other user 9, 8 through the Internet or such computer network, as discussed here before. The URL 16 or, preferably, the alias 17 is presented to the other user 9, 8 on his or her screen, such that the user 9, 8 knows who is wanting to communicate or at least what the topic is to be the communication will be about.

In a third example a first user 8 enters onto a website C of a second user 9, as for example shown in FIG. 2B. The first user 8 selects a product 21A or service 21B, in a known manner, for example by ticking a box 30 on the website C, to be ordered by the first user 8. Personal information is entered onto the filed 13, such as for example the first users name and address. Then the first user 8 pushes the button 12, requesting a unique URL 16 to be assigned to the product 21A, service 21B and/or service 21C selected. In this example a single URL 16 can be assigned to the order to be made by the first user 8 but preferably a unique URL 16 is assigned to each individual product 21A, service 21B or piece of information 21C. In this third example the first user orders a single product 21A, for example a bicycle, from the second user 9 through the website C. The unique URL 16 is assigned to the bicycle by for example assigning the bike's name to the URL 16 as an alias 17 and is made available to the second user 9 when making the order or purchase of the bike as product 21A. The first user can again assign to the URL 16 for example communication modes 15, time slots 14, 14A and/or 14B, expiry date 22 and/or code 26 as discussed before. In this example the second user 9 can also assign for example time slots 14, 14A, 14B to the URL 16, for example within the time slots 14, 14A, 14B as assigned by the first user 8. Then whenever the first user 8 and second user 9 for example want to communicate in relation to the bike purchased, they can use the URL 16 assigned to the bike.

In a fourth example a first user 8 accesses an access page W₁₆ as described before, requesting a URL 16, and assigning for example communication modes 15, time slots 14, expiry date 22 and the like, as discussed before. Then the first user 8 requests the computer system 2 to produce a code 26, especially a QR code (quick response code) 25 for the URL 16, which QR code 25 is printed onto a carrier 24. The first user then hands the carrier 24 with the QR code 25 printed thereon to a second user 9, for example a retailer, for future use. For example, but by no means limited to, a first user assigns a URL to a bike shop by assigning the bike shops name as an alias 17 to the URL. Then in the bike shop the first user 8 hands the carrier 24 with said URL 16 to the bike shop owner or employee as a second user 9, for example when offering his or her bike to the bike shop to be repaired or serviced. Then the bike shop owner or employee as a second user 9 can use said QR code 25 when wanting to contact the first user/bike owner 8, for example to inform the first user 8 of the progress in repairing or servicing the bike, to discuss the extend of repair or service needed, or for example for informing the first user that service is scheduled or to be scheduled for said bike. Obviously as alternative to or in addition to printing the QR code 25 the QR code 25 can be presented on a screen 25, such as but not limited to a screen 25 of a first or second communication device 3.

In a fifth example a first or second user 8 requests a series of URL's 16 to be assigned to him or her, for future use. These URL's can be stored, for example in a communication device 3 or in the computer system 2. Then later on, whenever the relevant first or second user 8, 9 needs to be able to communicate with a first or second user 8, 9 he or she can use one of these stored URL's.

In a sixth example a first user registers a unique URL 16 and assigns to it for example one or more communication modes 15, time slots 14, 14A and/or 14B, an alias 17 and an expiry date 22. In this embodiment the first user 8 may for example be a private person or a business offering for sale a second hand object on a website, whereas the second user 9 is for example another private person looking to buy such second hand object. The first user places an add on a website 31, as for example shown in FIG. 7, left hand side, with an indication 32 of for example the first users identity. On this website the first user 8 can offer a single object 21A for sale, or a variety 21 of products 21A₁, 21A₂, 21Aₓ, as schematically shown in FIG. 7. Next to each object 21Aₓ an alias 17A, 17B, 17ₓ is placed. A second user visiting said website 31 can then click the alias 17ₓ next to the object 21A the second user is interested in. The alias 17ₓ, more specifically the URL associated with said alias 17x cq said object 21Aₓ, will then redirect the second user to a web page 27 as shown in FIG. 7 right hand side, similar to that as shown in FIG. 5. On this webpage 27 the second user 9 can choose a mode of communication 15 available, for example VOIP 15A or text messaging 15B, and try to establish communication with the first user 8. By using the alias 17x cq URL 16 associated to said object 21Aₓ, to the first user 8 it will be directly clear what object 21Aₓ the second user wants to contact her or him, and be prepared. The first user 8 can then for example accept the request for communication, deny the said request or send a message to the second user with information, for example indicating another time that would be convenient for communication, propose another mode of communication 15, or for example inform the second user that the relevant object 25Aₓ is no longer available.

On said website 27 also the first user can make available other URL's 16 cq aliases 17, for example relating to similar objects 21Ax or other objects the second user 9 might also be interested in.

It may happen that a first user 8 or second user 9 does not want to make available any of the modes for communication, or at least not during a long period of time, or that availability time slots 14A available for both the first and second user 8, 9 do not overlap. In such case the relevant first and second user 8, 9 can place a message in the field 28 on the website 27. Also, the first user can for example indicate in said field 28 what bids have Already been made for the object, or give further information on said object or the first user 8 or any such information, which may make further communication unnecessary.

In a system or method according to the present disclosure the first and second users can be any type of user, for example private, public, commercial, foundations, governmental or the like. For example, the first user can be a private person, a business or a governmental organization, whereas the second user can also be a private person, a business or a governmental organization. Hence a system or method according to the disclosure can for example be used for communication between private persons, between a private person and a business or governmental organization, between a business and a governmental organization or between businesses.

In embodiments the same URL can be made available to a group of users, such that one user, for example a first user, can communicate with a group of users, for example a group of second users, through the same URL. In such embodiments for example the first user can be a teacher or trainer, or an organization, whereas the second users can for example be a class, a team or a group of customers.

FIG. 8 schematically shows a possible flow diagram or flow chart of a method and system according to the disclosure, by way of example only. In this flow chart in the left hand column steps and/or actions taken (actively or passively) by a first user 8 are shown, in the right hand side column steps and/or actions taken (actively or passively) by a second user 9, wherein in the middle column steps and/or actions taken (actively or passively) by a computer system 2 are shown. Wherein a computer system 2 can for example be cloud based, server based, app based or combinations thereof. First user 8 and second user 9 may be interchangeable, as discussed, for in embodiments users can alternatingly play a role of a first user 8 and a second user 9.

In step 101 a first user 8 requests the computer system 2 to provide a unique URL which will be used as a contact URL. This can for example optionally be initiated by a request 102 from a second user 9 to the first user 8 to provide a contact URL. In step 103 the requested unique URL 16 is provided by the computer system 2, generated by a URL generator. This URL 16 is sent to the first user 8 in step 104. The first user 8 then in step 105 configures the URL 16 to his or her needs, for example regarding possible communication modes, timeslots, alias, expiry dates and the like. Metadata thus provided relating to the URL 16 is stored in step 106 in the computer system 2, for later use.

After configuring the contact URL 16 the first user 8 then in step 107 makes the URL 16 available to the second user or users 9. The first user 8 can make the contact URL 16 available to the or each second user 9 in any suitable form, for example but not limited to in electronic form, as a code, such as a QR code, by providing an alias for the URL 16, through an NFC tag or the like.

In step 108 the second user receives the contact URL 16, which the second user can then open in step 109. The URL metadata stored in the computer system 2 is then retrieved in step 110, opening in step 111 the correct web page associated with the URL 16 in the computer system 2. The relevant metadata can for example be related to modes of communication available at the time the page is opened, timeslots during which such modes may be available, expiry date and whether the page is blocked or not-blocked at said time. If the webpage is blocked at the time the URL 16 is used in step 112 the blocked webpage will be shown. If the webpage is not-blocked at the time the URL 16 is used in step 112 the webpage will be shown to the second user 9 in step 113.

When the webpage is not-blocked the second user 9 in step 114 choses a communication mode from the communication modes available at the given time. For example the second user 9 can chose a video mode, shown in step 115, sending a call request to the first user 8. The first user 8 receives the call request in step 116, e.g. on his or her mobile phone. In step 117 the first user 8 can then decide to accept the call request of reject the call request. If the call request is rejected, the computer system 2 receives the reject signal (step 118) and presents a message on the webpage (step 119), for example visible on the screen of the second users mobile phone or computer, informing the second user 9 that the call request has been rejected.

If on the other hand the first user accepts the call request, a call accept signal is received by the computer system 2 in step 120. Then in step 121A and 121B an audio/video screen is presented on a communication device of the first user 8 and on a communication device of the second user 9, for example on their mobile phones or tablets or computer, enabling a two way audio/video communication between the first and second user.

In step 114 the second user can also chose a different communication mode available, for example a text based communication mode. In such mode the second user 9 can send a text message to the first user 8 (step 122) which is received by the first user (step 123) and vice versa.

In embodiments if in step 117 the call request is rejected in step 119 the second user can be redirected back to step 114, to chose an alternative communication mode, or can be provided in step 119 directly with an option to send a text message to the first user 8. In embodiments the first user 8 and/or the second user 9 can assign one or more standard messages to the URL 16, which can for example be presented at step 114 or step 119.

In step 124 the possibility is shown for the first user to block the contact URL 16, for example but not limited to if the URL 16 is compromised. For example because it is being used by a user not authorized for such use or is used for example in a manner abusive to the first user, or when the contact URL is no longer beneficial to the first user 8, for example when an event for what it was created has been accomplished. If the first user 8 blocks the contact URL 16 in step 124 this is registered in the computer system 2 (step 125), for example by updating the metadata of the URL or by elimination thereof.

FIG. 9 shows schematically four user's mobile phones 3, 4, here schematically indicated as three private persons “Smith” 8S, Johnson” 8J, “Young” 8Y and a commercial user “Bike shop” 9B. Furthermore in FIG. 9 schematically a data base 130 of a computer system 2 is shown, comprising a list of contact URL's 16.

In FIG. 9 schematically phones 3, 4 of users 8S, 8Y, 8J, 9B are shown representing electronic address books 131, or at least parts thereof, showing aliases 17, each associated with a URL 16 in the database 130. Obviously many more users 8, 9 can be associated with the system 1. The URL's 16 are all shared between at least two users 8, 9. For example, in the address book 131_{S} of user Smith 8S four aliases 17 are shown. In this embodiment the first alias 17A is “Bike 1” and is shared with user “bike shop” 9B, as indicated by the relevant arrows 17(1) and shown in the address book 131_{B}. These users “Smith” 8S and “Bike Shop” 9B can communicate, as discussed here before, about “Bike 1”. For example the user “Smith” 8S can chose alias 17A in the address book 131_{S} directing said user 8S to the relevant webpage through the URL 16 associated with said URL 16 and alias 17A. then when a communication mode is available, the user 8S can chose the or a communication mode and contact the user “Bike Shop” 9B. The user “Bike Shop” 9B will be presented on his or her communication device 4 the relevant alias 17A “Smith, Bike 1” associated with the URL 16, such that said user 9B knows that he or she is being contacted by user Smith 8S, concerning user Smith's 8S Bike 1. User “Bike Shop” 9B can then chose to accept or reject said communication and for example make information concerning user “Smith” 8B or the Bike 1 available to him or her. Similarly, when the user “Bike Shop” 9B wishes to communicate to user “Smith” 8S about Bike 1, user “Bike Shop” 9B can chose alias 17A from the address book 131_{B}, indicating to user “Smith” 8S that he or she is being contacted about Bike 1.

In embodiments the alias 17 for a URL can be the same for both (or all) users. In other embodiments both (or all) users 8, 9 can associate an alias 17 to the relevant URL 16, for their own benefit.

As can be seen the user “Smith” 8S has a second alias 17B named “bike 2”, which is registered with the user “Bike Shop” 9B as alias 17B too, here named “Smith; Bike 2”, indicating that this is also concerning a bike of user “Smith” 8S, but another bike than “bike 1”. A third alias 17C is called “school Jan” and a fourth alias 17D called “Washing machine”. These aliases 17 again are associated with URL's 16 in the database 130. As can be seen e.g. the third alias 16C has been provided to user “Johnson” 8J, and can for example be associated with a URL which is provided by user “Johnson” 8J to all students in a school class, of whom “Jan Smith” 8S is one.

Users “Young” 8Y and “Johnson” 8J both have an alias 17E, called “Vinted”, associated to a URL established for contacting each other with respect to a second hand clothing web site, here the site Vinted ® which can be a URL 16 established because of a single purchase e.g. made by user “Young” 8Y from user “Johnson” 8J, which can be blocked or terminated after said purchase, or can be a more permanent URL 16 when these users 8Y, 8J more often make purchases from each other through for example said website.

A user such as or example user “Bike Shop” 9B can in his or her computer system associate the aliases17 also to his or her own database concerning for example products and/or services, such as for example the relevant bikes, making said information directly available when contacted through the relevant URL 16 cq alias 17.

If a user 8, 9 is contacted through a URL 16 but it is not the proper other user 9,8 assigned to the URL 16, the user 8, 9 who initiated the request for the URL 16 can block or terminate the URL 16 from further use. Similarly the said user can block or terminate the URL 16 when it has fulfilled its purpose, for example when an action for which the URL 16 was initiated has been accomplished. This way the user can avoid being spammed with messages and requests for contact.

It shall be clear that for each alias 17 in the address books a URL 16 is comprised by the database 130, linked to the aliases 17 as indicated by the arrows in FIG. 9 by way of example.

The invention is by no means limited to the embodiments as specifically disclosed and/or discussed here before. Many variants and combinations are possible within the scope of the invention.

For example, a user can have a series of URL's 16 be made available to him or her, which can be stored for future use. When the user then for example makes a purchase or a computer request and has to enter a telephone number or email address he or she can pick one of the stored URL's 16 and, preferably after modifying it for the specific use parameters, enter this URL 16 in stead of a telephone number or email address.

Similarly the user can e.g. print a series of codes associated to the URL's 16, such that for example when he or she purchases a product or service in a physical store or market place or the like can hand out such printed code to the vendor, for future contact. The user can then edit the meta data of the URL later on his or her computer system or telephone or tablet or such communication device.

Such variants will be clear to the skilled person and are understood to fall within the scope of the invention as set forth in the following claims.

1. Method for managing communication between a first user and a second user, wherein a specific URL (uniform resource locator) is generated for the first user, which URL is made available to at least the second user, wherein the second user is enabled to establish a communication channel with the first user by using said URL, wherein the URL refers the second user to a web page of a web based computer system, wherein at said web page a choice is provided for a communication mode from a series of communication modes, including at least one and preferably at least two of VOIP, text messaging, video communication, voice messaging and emailing.

2. Method according to claim 1, wherein the first user registers in the said computer system for the URL which of the communication modes are to be made available to the second user when using the URL or vice versa.

3. Method according to claim 1 or 2, wherein a series of different URL's is generated for the first user, wherein at least one of the first user and the second user is enabled to register for each URL which of the communication modes are to be made available to the second user when using the URL.

4. Method according to claim 2 or 3, wherein one of the first user and the second user sets for at least one communication mode whether said communication mode allows for the possibility of one way communication or two way communication between the first user and the second user during at least part of the time the URL is available to the second user.

5. Method according to any one of the preceding claims 2-4, wherein at least one of the first user and the second user registers for the or each URL at least:
one time slot during which said URL can be used and/or when one or more of the communication modes registered for said URL can be used by the second user; and/or
one time slot during which said URL cannot be used and/or when one or more of the communication modes registered for said URL cannot be used by the second user.

6. Method according to any one of the previous claims, wherein the first user is enabled to allocate said at least one URL to a specified second user and/or to a product and/or service provided by or to said second user.

7. Method according to any one of the previous claims, wherein the or each URL is a unique URL, preferably a URL generated by said computer system.

8. Method according to any one of the preceding claims, wherein one of the first user and the second user assigns an alias to the or each URL, wherein preferably said alias is stored by the first user and/or the second user for later use and/or is used for making the URL available to the second user.

9. Method according to any one of the previous claims, wherein the URL is made available through a code and/or through a visual representation of such code, especially a QR code and/or wherein the code is made available in physical form, such as in printed form or as part of an NFC tag.

10. Method according to any one of the preceding claims, wherein the URL is made available to the second user electronically, preferably through an electronic form.

11. Method according to any one of the previous claims, wherein the URL is made available to the second user in printed form.

12. Method according to any one of the previous claims, wherein one of the first user and the second in the computer system registers an expiry date for the URL.

13. Method according to any one of the previous claims, wherein in the computer system the first user and/or second user assigns at least one further contact who can be contacted by the other user or users through the URL.

14. Method according to any one of the previous claims, wherein the first user opens a web page or web form through the Internet, wherein:
the first user enters said URL on said web page or web form; or
said URL is generated for the first user through the said web page and made available to the second user and to the first user through said web page or web form; or
said URL is generated for the first user by a separate web page and made available to the second user, preferably directly by said separate web page.

15. Method according to any one of the previous claims, wherein the URL is blocked or terminated by one of the first and second user, preferably the first user, permanently or temporarily.

16. System for enabling communication between a first user and a second user, wherein the system comprises a first communication device for the first user and a second communication device for the second user, said system further comprising a web based computer system comprising at least a generator for generating unique URL's, wherein the computer system is programmed to:
upon request from the first user generating a unique URL and transmitting said URL to the first user for making the URL available to the second user; and/or
upon request from the first user generating a unique URL and transmitting said URL to the second user; and/or
upon request from the second user generating a unique URL and making the URL available to the first user.

17. System according to claim 16, wherein the first communication device is or comprises at least one of a mobile phone or tablet and/or a computer, connected to or connectable to the computer system, and wherein the second communication device is or comprises at least a mobile phone or tablet and/or a computer, connected to or connectable to the computer system, wherein through the second communication device a website is made available to the first user on the first communication device, and wherein the URL is made available to the second user on said web site.

18. System according to claim 16 or 17, wherein the computer system comprises at least said generator and said computer system comprises at least a computer program enabling a first user to:
assign to said URL at least one communication mode, wherein said at least one communication mode is preferably chosen including at least one and preferably at least two of VOIP, text messaging, video communication, voice messaging and emailing; and/or
assign to said URL at least one time slot during which said at least one communication mode is to be made available to the second user; and/or
assign to said URL at least one time slot during which said at least one communication mode is not to be made available to the second user; and/or
assign an alias to said URL; and/or
allocate said at least one URL to a specified second user and/or to a product and/or service provided by or for said second user; and/or
assign an expiry date for the URL.

19. System according to any one of claims 16-18, wherein said system is further programmed to assign a code, preferably at least an optically readable code, more preferably at least a QR code to the said unique URL.

20. System according to claim 19, wherein said code is represented on a carrier or visualized on a screen.

21. System according to any one of claims 16-20, wherein the system is at least partly app based.

22. Computer readable computer product comprising computer readable instructions for performing a method according any one of claims 1-15.

23. Computer system, comprising at least a computer program designed for performing a method according to any one of claims 1-15.
